(19) United States
(12) Patent Application Publication
(10) Pub. No.: US 2019/0227643 A1
(43) Pub. Date: Jul. 25, 2019

(54) STYLUS AND MOBILE DEVICE COMBINATION

(71) Applicant: Barbara Lee, Rural Hall, NC (US)

(72) Inventor: Barbara Lee, Rural Hall, NC (US)

(21) Appl. No.: 15/880,159

(22) Filed: Jan. 25, 2018

(51) Int. Cl. G06F 3/0354; G06F 3/038; G06F 3/041

(52) U.S. Cl. CPC G06F 3/03545; G06F 3/0416; G06F 3/0383

(57) ABSTRACT

A mobile computing system comprises a mobile computing device comprising a first hook and loop material secured to a back of the mobile computing device using a first adhesive. The hook and loop material covering a majority portion of the back of the mobile computing device and extending across the back of mobile computing device from a first side to a second side and covering a majority portion of at least the first side. A stylus associated with the mobile computing device comprising a second hook and loop material forming a tube with the stylus inserted therein and secured to the stylus using a second adhesive, said hook and loop material covering a majority of the stylus. The first and second first hook and loop material engaged when the stylus makes contact with the mobile computing device for secured storage when not in use.

### CROSS-REFERENCE TO RELATED APPLICATION(S)

Not applicable

### BACKGROUND OF THE INVENTION

### 1. Field of Invention

The present invention relates to the field of styluses and mobile communication devices, more particularly to mating a stylus and a mobile device.

### 2. Description of Related Art

Mobile computing devices generally operate to function in conjunction with a stylus of electronic pen used to interface with a touch sensitive screen. Broadly stated, such mobile devices take the form of a smart phone or a tablet. The purpose of the stylus is to provide for a more precise contact with the computing device's touch sensitive screen. Specifically, smaller screens on smart phones and tablets are easier to use and interact with by utilizing a stylus. However, the stylus is generally separate from the mobile device and typically integrated for storage with the device in some fashion.

Current attempts to integrate stylus storage require a specific device to accommodate the stylus storage within the device housing, but this fails to allow for a retrofit attachment system.

Based on the foregoing, there is a need in the art a system, which will facilitate a simple system and apparatus for attaching and storing stylus to a mobile device and permit retrofitting existing devices.

### SUMMARY OF THE INVENTION

The present invention describes a Velcro attachment between the stylus and an external surface of the device or housing.

A mobile computing system comprises a mobile computing device comprising a first hook and loop material secured to a back of the mobile computing device using a first adhesive. The hook and loop material covering a majority portion of the back of the mobile computing device and extending across the back of mobile computing device from a first side to a second side and covering a majority portion of at least the first side. A stylus associated with the mobile computing device comprising a second hook and loop material forming a tube with the stylus inserted therein and secured to the stylus using a second adhesive, said hook and loop material covering a majority of the stylus. The first and second first hook and loop material engaged when the stylus makes contact with the mobile computing device for secured storage when not in use.

The first hook and loop material extends across the back to cover a majority of the second size.

The first hook and loop material consist of the hook part of the first hook and loop material.

The second hook and loop material consist of the loop part of the first hook and loop material.

The first adhesive and second adhesive comprise a permanent adhesive.

The first hook and loop material consist of the hook part of the first hook and loop material.

The first hook and loop material comprises a cutout to accommodate a control interface.

The first hook and loop material covers between about 70% and 100% of the back of the mobile computing device.

The second hook and loop material covers between about 50% and 90% of the back of stylus.

The mobile computing device comprises one of a smart phone or a tablet.

Advantages:

1. Improved convenience.

2. Improved retention of the stylus.

3. Improved efficiency with quick access to the stylus.

4. Improved stylus application to retrofit installation.

5. Reduced cost of replacement through lost stylus.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the mobile device, according to an embodiment of the present invention; and

FIG. 2 is a perspective view of the stylus, according to an embodiment of the present invention.

### DETAILED DESCRIPTION OF PREFERRED EMBODIMENTS

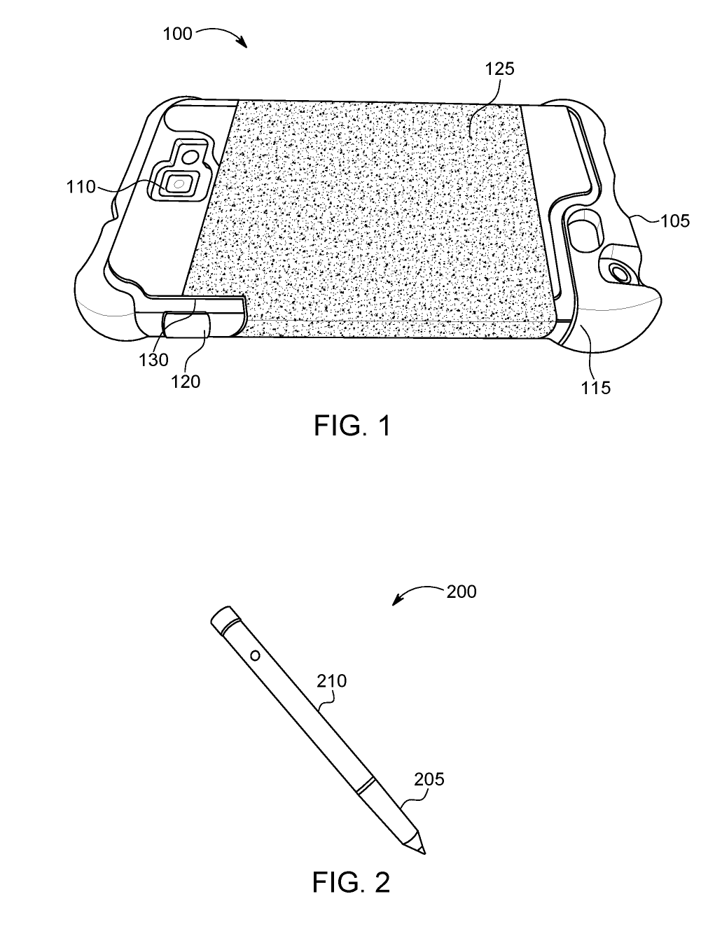

Preferred embodiments of the present invention and their advantages may be understood by referring to FIGS. 1-2, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

FIG. 1 shows a perspective back view a mobile device 100 in an embodiment of the invention. As depicted, the back of a smart phone case 105 can include a camera lens 110. Back of smart phone case 105 includes a side 115. Side 115 includes a control input 120. The back of smart phone case 105 can include a hook and loop fastener material 125 such as Velcro®. The hook and loop fastener material 125 can cover a majority portion of the back of smart phone case 105 and extends to the sides to cover a major portion of the side 115. A cutout 130 in the hook and loop fastener material 125 to leave control interface 120 fully exposed.

FIG. 2 shows a perspective side view of a stylus 200 in an embodiment of the invention. Stylus 200 can include an uncovered section 205 making up a minority portion of stylus 200. A hook and loop fastener material covered section 210 can make up a majority portion of stylus 200 and can form a tubular structure to receive the body of stylus 200.

In an embodiment, the hook and loop fastener material 125 on smart phone case 105 can comprise the hard, plastic hook half of Velcro®. The hard, plastic material can serve to enhance protection of the smart phone 100 from impact damage in addition to serving as an attachment mechanism for the stylus 205. The hook and loop fastener material 125 can be attached to the back of smart phone case 105 using an adhesive. The adhesive can be a permanent adhesive such as an epoxy, thermal glue, or Elmer's®. The hook and loop material 125 can be attached directly to smart phone 100 rather than smart phone case 105.

In an embodiment, the hook and loop material 210 can comprise the soft, fabric, loop half of Velcro®. As previously noted, the Velcro® can take the form of a tube into which the body of stylus 200 fits. The hook and loop material 210 can be held in place by friction or an adhesive. The adhesive can be permanent, such as an epoxy, thermal glue, or Elmer's®.

In an embodiment, the covered stylus 200 can be easily attached and removed from the covered smart phone 100. The hook and loop fastener material 125 and 210 allows for easy storage and access of stylus 200. The attached stylus 200 can be held securely, allowing for quick and easy access and use with smart phone 100. At the same time, when attached for storage when not in use, the stylus 200 is secured to smart phone 100 and not prone to loss or misplacement.

In an embodiment, the hook and loop material 125 covers at least about 80% of the total area of the back of smart phone 100. In other embodiments, the hook and loop material 125 can cover about 100% of a back of a mobile device. In an embodiment, the hook and loop material 125 can cover between about 70% and 100%. Furthermore, the hook and loop material 125 can cover across the back of the mobile device to cover the majority of at least one side of the mobile device such as side 115, and can further cover the majority of both sides. Additionally, the hook and loop material 125 can extend to cover each side of camera lens 110. In an embodiment, an access opening to a battery compartment in the smart phone 100 can be accommodated by the hook and loop material.

In an embodiment, the hook and loop material 210 covers at least about 80% of stylus 210. In other embodiments, the hook and loop material 210 can cover about 90% of stylus 210. In embodiment, the hook and loop material 210 can cover between about 50% and 90% of stylus 210.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A mobile computing system, comprising:
a mobile computing device comprising a first hook and loop material secured to a back of the mobile computing device using a first adhesive;
said hook and loop material covering a majority portion of the back of the mobile computing device and extending across the back of mobile computing device from a first side to a second side and covering a majority portion of at least the first side;
a stylus associated with the mobile computing device comprising a second hook and loop material forming a tube with the stylus inserted therein and secured to the stylus using a second adhesive, said hook and loop material covering a majority of the stylus; and
said first and second hook and loop material engage when the stylus makes contact with the mobile computing device for secured storage when not in use.

2. The mobile computing system of claim 1, wherein the first hook and loop material extends across the back to cover a majority of the second side.

3. The mobile computing system of claim 1, wherein the first hook and loop material consist of the hook part of the first hook and loop material.

4. The mobile computing system of claim 1, wherein the second hook and loop material consist of the loop part of the first hook and loop material.

5. The mobile computing system of claim 1, wherein the first adhesive and second adhesive comprise a permanent adhesive.

6. The mobile computing system of claim 1, wherein the first adhesive and second adhesive comprise the same adhesive.

7. The mobile computing system of claim 1, wherein the first hook and loop material comprises a cutout to accommodate a control interface.

8. The mobile computing system of claim 1, wherein the first hook and loop material covers between about 70% and 100% of the back of the mobile computing device.

9. The mobile computing system of claim 1, wherein the second hook and loop material covers between about 50% and 90% of the back of the stylus.

10. The mobile computing system of claim 1, wherein the mobile computing device comprises one of a smart phone or a tablet.
